(19) United States
(12) Patent Application Publication
(10) Pub. No.: US 2012/0216410 A1
(43) Pub. Date: Aug. 30, 2012

(54) Clipper deflector for deflecting air and cuttings away from operator

(76) Inventor: Albert Beam, Downingtown, PA (US)

(21) Appl. No.: 12/932,369

(22) Filed: Feb. 24, 2011

(51) Int. Cl. B26B 19/38; B26B 19/28

(52) U.S. Cl. 30/123; 30/216

(57) ABSTRACT

A motor cooling air flow deflector comprises a channel over at least one of the air flow outlet vents for electric motor cooling air from the periphery or circumference of a generally cylindrical housing of a clipper. The channel may be an inverted U-shaped structure having a span covering at least 120 degrees of the housing, and preferably more than 180 degrees. The inverted U-shaped structure is provided with a downwardly directed first end with a flared input and a second end with a vane for directing air flow out of the channel and backwardly along the housing of the clipper. The channel is adapted to conform to the variations in the generally cylindrical shape of the housing. The air flow deflector may be an attachment to an existing clipper or it may be fabricated or molded into the housing of a clipper.

### FIELD OF THE INVENTION

The present invention relates to a clipper motor cooling air deflector system for deflecting cooling air and clippings away from the operator. More particularly, the present invention relates to a clipper motor cooling air deflector which deflects cooling air along with cuttings, such as hair, from the clipper away from the operator without interfering with the proper air flow for cooling of the motor.

### BACKGROUND OF THE INVENTION

For many years, clippers have been utilized for clipping the hair of horses and other animals, people, and things such as carpeting. These clippers utilize an electric motor within a housing wherein cooling air is drawn into the housing across the motor and out through outflow vents. The housings are typically generally cylindrical, and although they may have flattened portions and other deviations from exactly cylindrical, they are generally an elongated cylindrical structure with an electric motor and an air flow cooling means contained therein, which causes substantial outflow of air directed through outflow vents radially outward from the center and into the face of the operator. When the operator is trimming the hair of animals, human hair, carpeting or other material or living things which are to be clipped, the cuttings of the clipper are often thrown into the face of the operator. This presents an extremely uncomfortable and unhealthy working and environmental condition. This condition has existed for many years in this field. of endeavor, some of these clippers having been in use for more than seventy years without remedying this significant uncomfortable and unhealthy working condition.

### SUMMARY OF THE INVENTION

An advantage of the present invention is that it produces a clipper in which motor cooling air passing through outlet vents which may carry clippings is directed away from an operator.

Another advantage of the present invention is that by directing the motor cooling air away from the operator, particularly away from the face of the operator, clippings from the clipper which may be airborne are not blown into the face of the operator or otherwise in the direction of the operator.

This cooling air may have ozone in it as it passes over an electric motor which may have brushes causing sparking and ozone. Another advantage of the present invention is that the ozone laden air is directed away from the operator.

Another advantage of the present invention is that the deflector of the present invention does not obstruct the motor cooling air from flowing properly through the outlet vents.

Another advantage of the present invention is that it may be adapted as an after market attachment to existing clippers or it may be built into the housing of new clippers being manufactured.

Another advantage of the present invention is that it provides significant advantages in work place comfort and safety without significant additional cost.

Briefly and basically, in accordance with the present invention, apparatus is provided which forms a motor cooling air deflector on a clipper having an electric motor within a housing and means for forcing cooling air over the motor and through one or more outlets or outlet vents in the housing of the clipper, wherein the housing is comprised of a generally cylindrical shape.

The term “generally cylindrical shape” as used throughout means any generally cylindrical in cross section shape which may have flattened or other non-circular portions on its circumference, which may be hexagonal, octagonal or any other shape. It is generally an elongated shape having a periphery which somewhat approximates in cross section a circular shape, although it need not be circular in cross section.

The apparatus of the present invention on a clipper, is in the form of a motor cooling air deflector means which comprises a channel over at least one of the air flow outlets. Preferably, the channel would cover all of the air flow outlets which are directed upwardly and out of either side of the housing, but leaving downwardly directed air free for air flow. The term upwardly and downwardly will be defined more particularly with respect to the drawings hereinafter, but generally upwardly is directed upwardly from the top of the clipper, that is radially upwardly in the direction of where an operator would normally be positioned. Downwardly refers to the radially outward direction which is directed to the object, animal or person being clipped. It is understood that upwardly is defined in reference to the top of the clipper and the airflow although defined to be upwardly may actually be directed downwardly in certain circumstances such as where the clipper is being used to clip hair from the underside of a horse.

The channel means, which may be a generally inverted U-shaped structure has a first and second end and covers a span of at least 120 degrees of the circumference of the housing. The span of the clipper covered in a preferred embodiment would be in excess of 180 degrees. The channel is provided with a first and a second end downwardly directed. The channel is provided with a first end which in one preferred embodiment may have a flared input and provided at a second end with a vane for directing air flow out of said channel and backwardly along the housing of the clipper. The flared input end, in a preferred embodiment, may be provided with a shield on the forward side, that is the side closest to the clipping blades, to help prevent clippings from being drawn into the channel as a result of rotation of an air movement means such as a fan. Preferred embodiments will be described more fully hereinafter.

### BRIEF DESCRIPTION OF THE DRAWINGS

For the purpose of illustrating the invention, there are shown in the drawings forms which are presently preferred; it being understood, however, that this invention is not limited to the precise arrangements and instrumentalities shown.

FIG. 1 is a view in perspective of a clipper utilizing an air and cuttings deflector attachment in accordance with one preferred embodiment of the present invention.

FIG. 2 is a partially broken away exploded view in perspective showing the deflector being attached to a clipper in accordance with the embodiment of FIG. 1 of the present invention.

FIG. 3 is a cross sectional view taken along line 3-3 of FIG. 1.

FIG. 3A is a partially broken away cross sectional view taken along line 3A-3A of FIG. 1.

FIG. 4 is a partially broken away cross sectional view taken along line 4-4 of FIG. 3.

FIG. 5 is a partially broken away view in perspective of an embodiment of the present invention utilizing a resilient attachment means for attaching the air and clippings deflector to the clipper.

FIG. 6 is a partially broken away exploded view in perspective of a deflector in accordance with FIG. 5 being attached by resilient means or a leaf spring.

FIG. 7 is a cross sectional view taken along line 7-7 of FIG. 5.

FIG. 8 is a partially broken away view in perspective of an air and clippings deflector in the form of an attachment which is mounted to the clipper by other mechanical means as illustrated being a key hole and key structure.

FIG. 9 is a partially broken away exploded view in perspective of the embodiment of FIG. 8 showing keys on the deflector attachment being inserted into key holes in the housing of the clipper.

FIG. 10 is a cross sectional view taken along line 10-10 of FIG. 8.

FIG. 11 is a partially broken away perspective view of a deflector mounted by mechanical means in the form of fasteners to the clipper.

FIG. 12 is a cross sectional view taken along line 12-12 of FIG. 11.

FIG. 13 is a partially broken away view in perspective of an air and clippings deflector formed intrinsically as a part of a housing of a clipper.

FIG. 14 is a partially broken away in perspective of a clipper with a generally cylindrical housing having a flattened portion to which the air and cuttings deflector is formed to conform.

FIG. 15 is a partially broken away exploded view in perspective of the air and cuttings deflector of FIG. 14 being attached to the clipper.

FIG. 16 is a cross sectional view taken along line 16-16 of FIG. 14.

FIG. 17 is a partially broken away cross sectional view taken along line 17-17 of FIG. 16.

FIG. 18 is a partially broken away view in perspective of an air and cuttings deflector attachment as may be attached to a clipper utilized for clipping human hair.

FIG. 19 is a partially broken away exploded view in perspective of the embodiment of FIG. 18 showing the deflector attachment being attached to the clipper.

FIG. 20 is a cross sectional view taken along line 20-20 of FIG. 18.

FIG. 21 is an elevation diagram showing the span of the deflector around the generally cylindrical housing of the embodiment of FIGS. 1 through 4.

FIG. 22 is an elevation view of the span of coverage of the deflector around the generally cylindrical housing of the clipper of the embodiments of FIGS. 14, 15, 16 and 17.

FIG. 23 is an elevation view of the span of coverage of a deflector around the generally cylindrical housing of the embodiment of the clipper illustrated in FIGS. 18, 19 and 20.

### DETAILED DESCRIPTION OF THE PREFERRED EMBODIMENTS

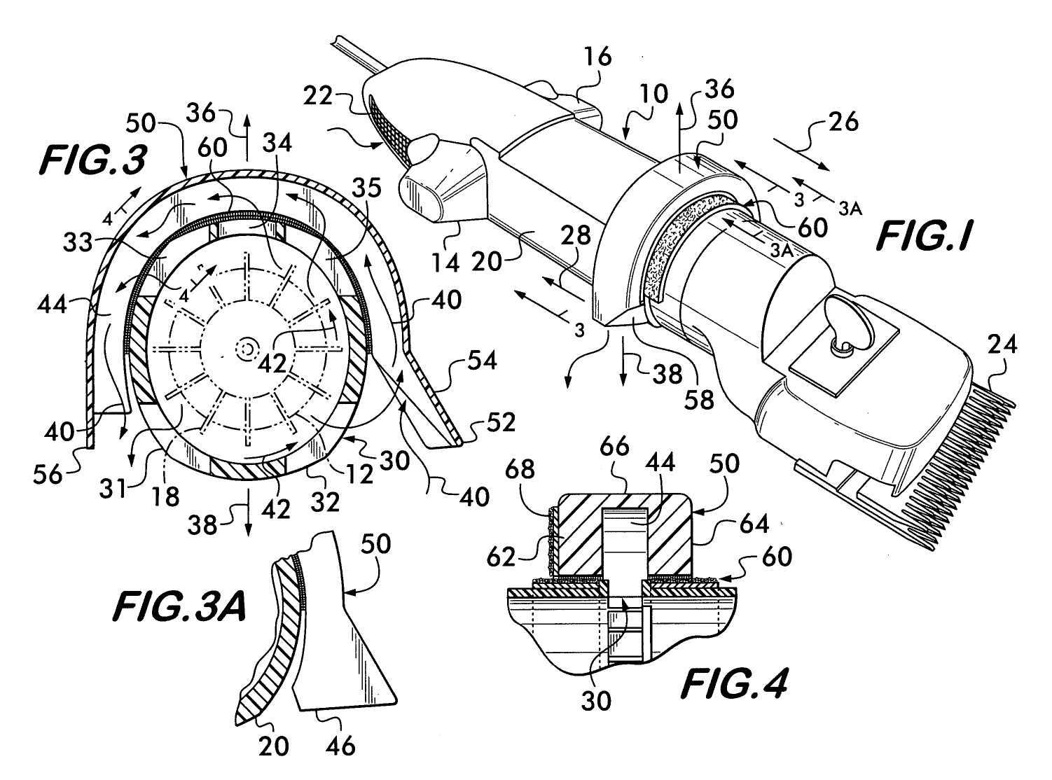

Referring now to the drawings, wherein like numerals indicate like elements, there is shown in FIGS. 1, 2, 3, 3A, 4 and 21 a presently preferred embodiment of the invention utilized in connection with a clipper 10 which may be considered to be a heavy duty clipper utilized for clipping horse hair, other coarse hair of animals, such as sheep and other animals, carpeting and other material which might be considered to be coarser or thicker than human hair. Clipper 10 has an electric motor 12, as shown generally by dotted outline in FIG. 3, which drives clipper blades 24. Electric motor 12 may be of various types, but as shown in the embodiment of FIG. 1 is provided with housings 14 and 16 for brushes.

Means for forcing cooling air 18 over motor 12 is also indicated generally in dotted outline form. Means for forcing cooling air 18 may be any suitable type of fan or other means for moving air, including but not limited to propeller type fans, centrifugal fans such as straight radial blade, curved blade and squirrel cage fans and any other suitable means for moving air over motor 12 for cooling of the motor. Cooling air is drawn into the housing 20 through one or more inlet vents 22, through housing 20 and over motor 10 to cool the motor. In electric motors having brushes, there may be some arcing which may create ozone.

The cooling air after being drawn over motor 12 exits through one or more outlets or outlet vents 30 in the housing 20 of the clipper. Outlets or outlet vents 30 may be comprised of multiple outlets and as illustrated in FIG. 3 for the specific clipper of FIGS. 1-4 and 21 clipper may be comprised of five outlet vents 31, 32, 33, 34 and 35. However, it is understood that more or less vents may be utilized in a particular clipper.

As illustrated in FIGS. 1 and 3, upward is defined to be in the direction of arrows 36, that is directed away from the top of clipper 10. Downward or downwardly are defined to be away from the bottom of clipper 10 indicated by the direction of arrows 38. In other words, upwardly is in the direction away from the top of the clipper, normally in the direction of the operator and particularly normally in the direction of the face of the operator. Downwardly is in the direction away from the bottom of the clipper and is usually in the direction of the animal, person or object being clipped. In some circumstances, what is referred to herein throughout as upwardly directed air flow may actually be downward with respect to the earth, for example where the underside of a horse or other animal is being clipped and the clipper is physically upside down. The terms upward or upwardly and downward or downwardly as used throughout including the claims are as defined herein.

It may be seen that outlets or outlet vents 31 and 32 are substantially downwardly directed. Outlet vent 34 is upwardly directed and outlets or outlet vents 33 and 35 are generally upwardly and somewhat laterally directed.

The direction of rotation of the means 18 for forcing cooling air over motor 12, such as propeller or fan wheel 18 is counter clock wise as indicated in FIG. 3 by arrow 42 for the embodiment of FIGS. 1, 2, 3, 3A, 4 and 21. Although the majority of the air flow is in the direction from the rear to the forward part of housing 20 of clipper 10, there is also some airflow in the direction of arrow 42 due to the rotation of the means for forcing cooling air or fan 18 and this is shown by the airflow arrows 40 in FIG. 3.

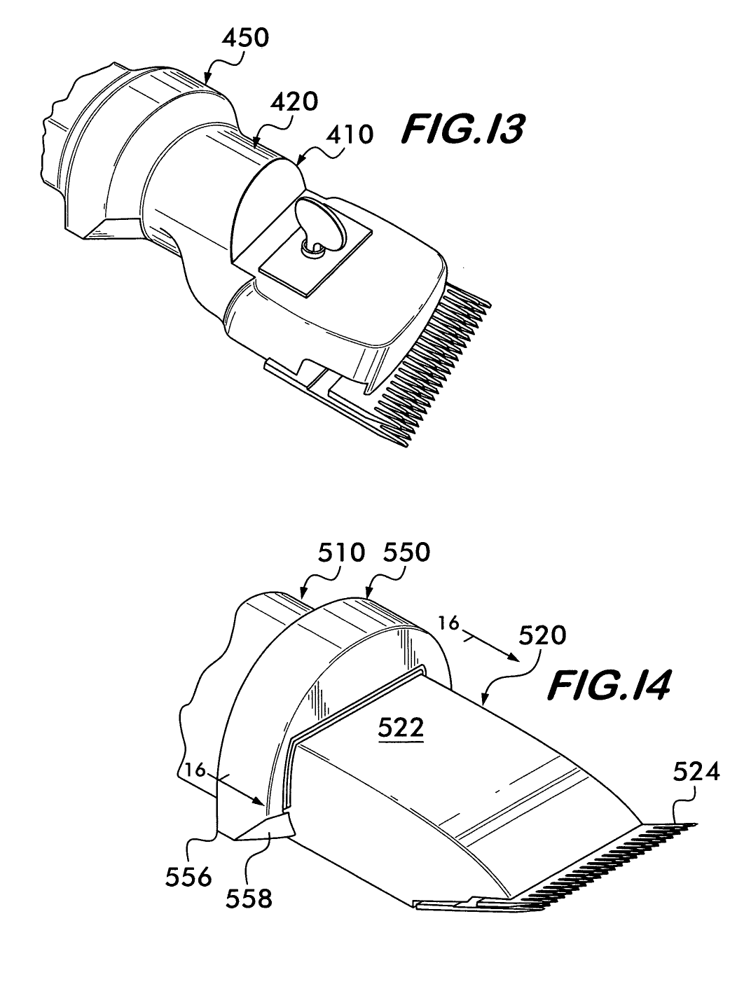

The housing 20 of clipper 10, and the various other clippers described herein and referenced in the claims, is “generally cylindrically” shaped. Generally cylindrical means herein throughout an elongated housing having a somewhat circular shape in cross section, but the shape need not be perfectly cylindrical and in fact may have significant flattened portions such as is illustrated in the embodiment of FIGS. 14, 15, 16, 17 and 22 where there is a substantial flattened portion in the clipper housing. Additionally, other variations from cylindrical may occur including shapes such as hexagonal, octagonal and other variations and deviations as long as the channel or air flow deflector of generally inverted U-shaped structure is adapted to conform to the shape of the housing. This definition set forth herein and above is the definition of “generally cylindrical” to be used throughout including the specification and claims.

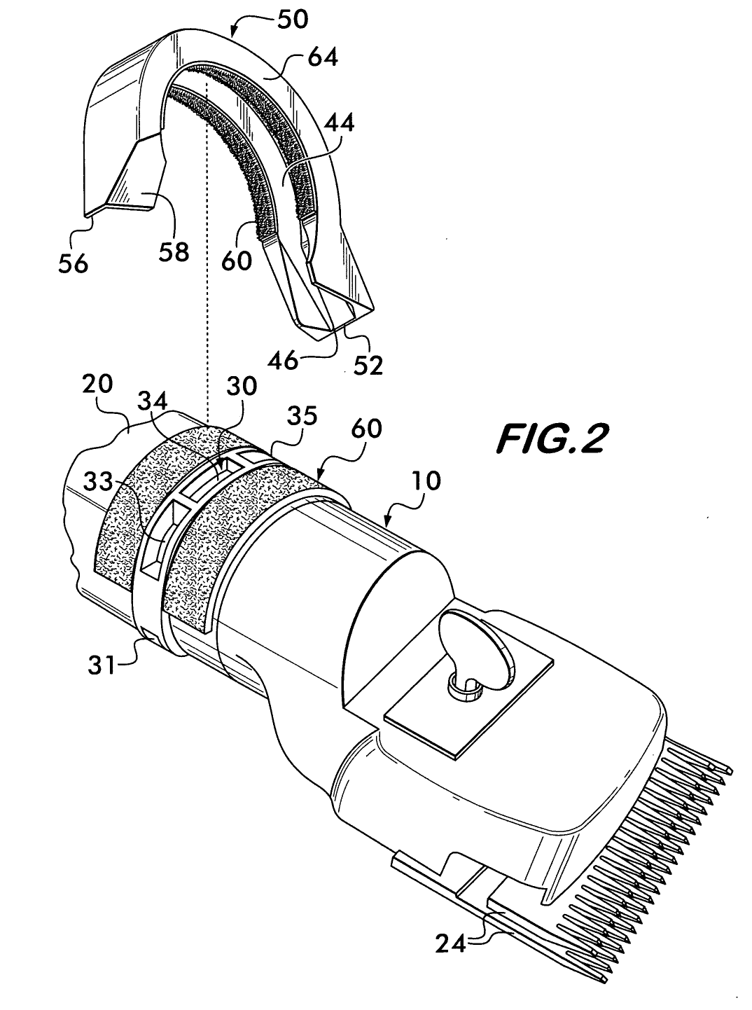

Referring now again to FIGS. 1 through 4 and 21, there is shown a motor cooling airflow and cutting or cutting debris deflector 50 which is comprised of a channel 44 over at least one of the airflow outlets or outlet vents 30. As best seen in FIGS. 2 and 3, airflow and cutting debris deflector 50 is provided with a first end 52 which is provided with a flared input 54. Flared input 54 is provided on its forward or leading side with a shield 46 best seen in FIGS. 2 and 3A to help prevent cuttings or cutting debris from clipper blades 24 from being drawn into channel 44 of deflector 50 and to help prevent cutting debris from being drawn into the air flow. Deflector 50 has a second end 56 which is provided with a vane 58 for directing airflow backwardly along housing 20 of clipper 10. Backward or backwardly is indicated by arrow 28 and forward or forwardly is indicated by arrow 26 in FIG. 1. Although the bulk of the airflow is drawn by the fan from input vent 22 and through housing 20 over motor 12, since air forcing means or fan 18 is rotating in the counter clockwise direction 42 as viewed in FIG. 3, air is drawn into first end 52 of airflow deflector 50 and out of second end 56 and is directed by vane 58 backwardly along housing 20. If the air forcing means or fan 18 were rotating in the opposite direction, everything would just merely be reversed. Of course fan rotation in either direction is within the scope of the present invention. Air deflector 50 prevents air with cuttings or cutting debris from blowing towards an operator and particularly prevents it from blowing into the face of an operator. This is particularly important since cutting blades 24 of the clipper 10 are cutting hair or other material and this cut material is airborne and would be blown into the face of the operator. These cuttings or debris would be breathed in by the operator causing adverse effects on the operator's respiratory system, particularly if done over a period of time.

The span of airflow deflector 50 around the circumference or perimeter of housing 20 between first end 52 and second end 56 should be at least 120 degrees to prevent airflow from being directed directly into the face of the operator. Use of the term circumference throughout is not intended to in any way limit this invention or the housings to which it is applied to being circular in cross section, but covers all housings and deflectors which conform to the shape of the housing even though it may have flattened portions or may have other deviations from circular as defined above with respect to “substantially cylindrical”. Preferably, the span between the first end 52 and the second end 56 of the air deflector 50 is more than 180 degrees and in a presently preferred embodiment as illustrated in FIG. 21, the span between the first end 52 and second end 56 may span approximately 246 degrees or 260 degrees if measured between flared input 54 and shield 46 and the second end 56, respectively, as illustrated in FIG. 21. In other words, the span of deflector 50 around the circumference of housing 20 between second end 56 and the shield would be approximately 246 degrees. The coverage of deflector 50 around the housing 20 from second end 56 to the inside of flared input 54 would be approximately 260 degrees.

In a presently preferred embodiment, airflow deflector 50 is comprised of a channel 44 which receives the outflow air from outlets or outlet vents 30 and allows the air to pass in an unobstructed manner downwardly in the direction of arrow 38 out of deflector 50, without being directed into the face of the operator or generally in the direction of the operator. In a presently preferred embodiment as best illustrated in FIGS. 2 and 4, the channel may be in the form of an inverted U-shape having legs 62 and 64 connected at their outer end by a member 66. The lower end of the legs are shaped to conform to the housing 20 of clipper 10 in the area immediately adjacent outlets or outlet vents 30. The air deflector channel or inverted U-shaped structure is attached to or secured to the housing by various suitable means. As illustrated in the embodiment of FIGS. 1 through 4, this may be done by suitable hook and loop fasteners 60 which form a bond between the legs of the inverted U-shaped member and the housing. The hook and loop fasteners are commercially available under the Trademark “Velcro”. The hook and loop fasteners 60 not only form a means for securing channel 44 or deflector 50 to housing 20, but also form a seal between the inverted U-shaped member legs and the housing. One of the hook or loop fasteners is attached to the housing by adhesive and the other of the hook and loop is attached to the ends of the inverted U-shaped legs 62 and 64 by adhesive. In a presently preferred embodiment, Velcro or a resilient cushioning member 68 may be provided on the back side of deflector 50 as best illustrated in FIG. 4 to provide a cushioning effect for the hand or fingers of an operator.

The embodiment of the invention shown in FIGS. 1-4 and 21 and described herein was built and tested to successfully operate as intended deflecting air and cutting debris away from the operator.

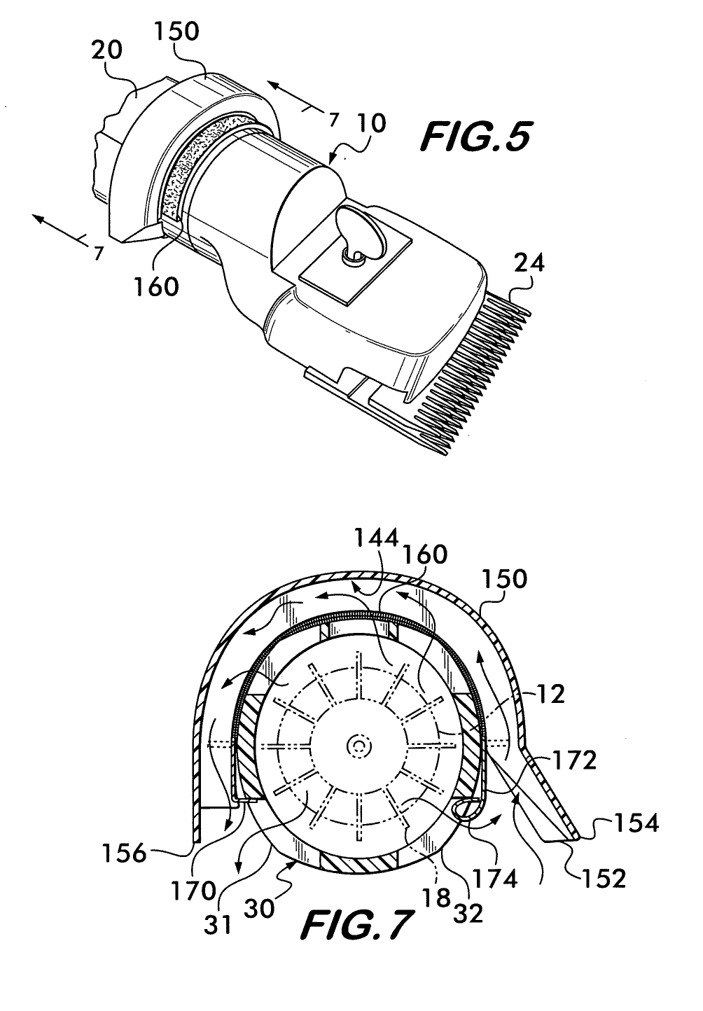

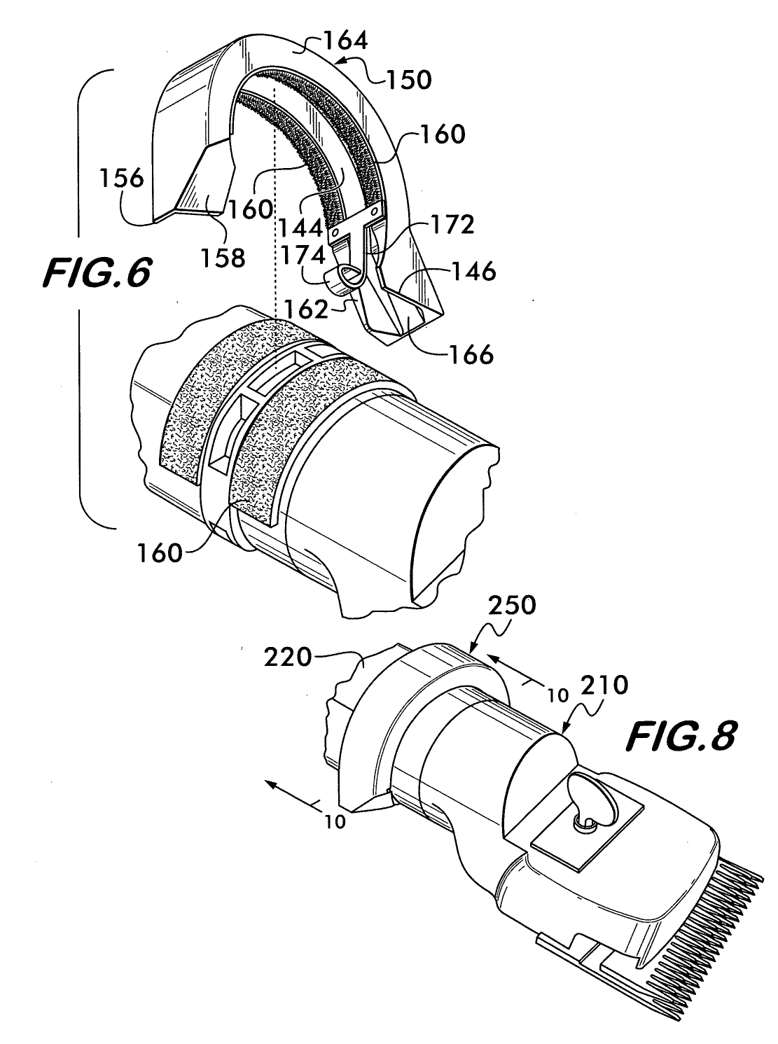

Referring now particularly to the embodiment shown in FIGS. 5, 6 and 7, there is shown an embodiment of the present invention wherein an air and cuttings deflector attachment 150 is attached to the generally cylindrical housing 20 of a clipper 10 by mechanical means and particularly by mechanical means in the form of a catch 170 for engaging a sidewall surface of a first outlet 31 in the housing as best seen in FIG. 7 and a spring member 172 with a curled end 174 or otherwise rounded end for engaging a sidewall of a second outlet 32 in the housing as best seen in FIG. 7. The channel is attachable to the housing and removable from the housing by flexing of the spring member 172. Velcro 160 or other resilient sealing means is utilized primarily as a seal between the deflector attachment 150 and the housing 20. The curled end 174 of spring member 172 enables or enhances the ability of the spring member 174 to slide over housing 20 and be engaged within an outlet or outlet vent opening of housing 20. The curled end 174 also allows for easier disengagement of spring member 172 and deflector 150 from generally cylindrical housing 20 of clipper 10. The input end or first end 152 is provided with a flared input 154 which includes a shield 146 as described with respect to the previous embodiment of FIGS. 1 through 4 and 21. The second end 156 is provided with a vane 158 for directing air flow backwardly as described with respect to the previous embodiment described with respect to FIGS. 1 through 4 and 21.

The deflector 150 operates in a similar manner to that described with respect to deflector 50, including the deflection of air away from the operator by means of the use of channel 144 comprised of an inverted U shaped structure having legs 162 and 164 which conform to the shape of housing 20. Deflector 150 is provided with a shield 146 on its leading edge of the input 152 and a rearward deflecting vane 158. As described with respect to deflector 50, deflector 150 does not obstruct the cooling motor airflow and prevents air and clippings from being thrown generally towards the operator and particularly from being thrown into the face of the operator.

The embodiment of the invention shown in FIGS. 5-7. and described herein was built and tested to successfully operate as intended deflecting air and cutting debris away from the operator.

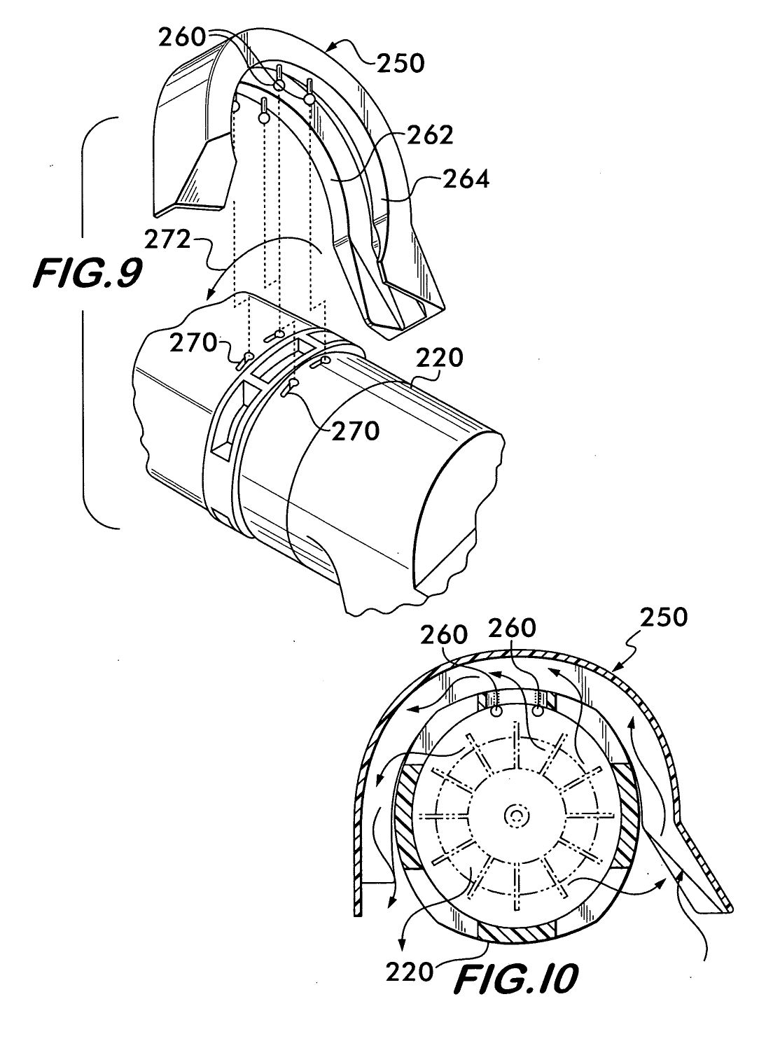

Referring now to the embodiment shown in FIGS. 8, 9 and 10, there is shown an embodiment of the present invention wherein an air and cuttings deflector attachment 250 is attached to the generally cylindrical housing 220 of a clipper 210 by mechanical means and particularly by mechanical means in the form of keys 260 which are insertable and lockable in key holes 270 by means of a short or small amount of rotation of deflector 250 on cylindrical housing 220. As best illustrated in FIG. 9, the keys 260 are inserted into the enlarged opening of the key hole 270 and then deflector 250 is rotated slightly in the direction of arrow 272 to lock deflector 250 onto housing 220 by engaging the enlarged portions of keys 260 in the narrow channels of the key holes 270. The key holes 270 may be formed into housing 220 by molding or may be machined into the housing as desired at the time of manufacture or thereafter.

As best illustrated in the cross sectional view of FIG. 10, the keys 260 are shown engaged within the slots of the key holes 270 securely attaching deflector 250 to housing 220. The remaining structure of deflector 250 is substantially the same as that described with respect to deflector 50 with respect to FIGS. 1 through 4 and 21. As illustrated in FIGS. 8, 9 and 10, the hook and loop fastener may be eliminated and a seal may not be needed where the deflector is precisely formed to the shape of the housing 220. Alternatively, a resilient seal of various types may be provided between the bottoms of legs 262 and 264 of inverted U-shaped channel of deflector 250 and housing 220.

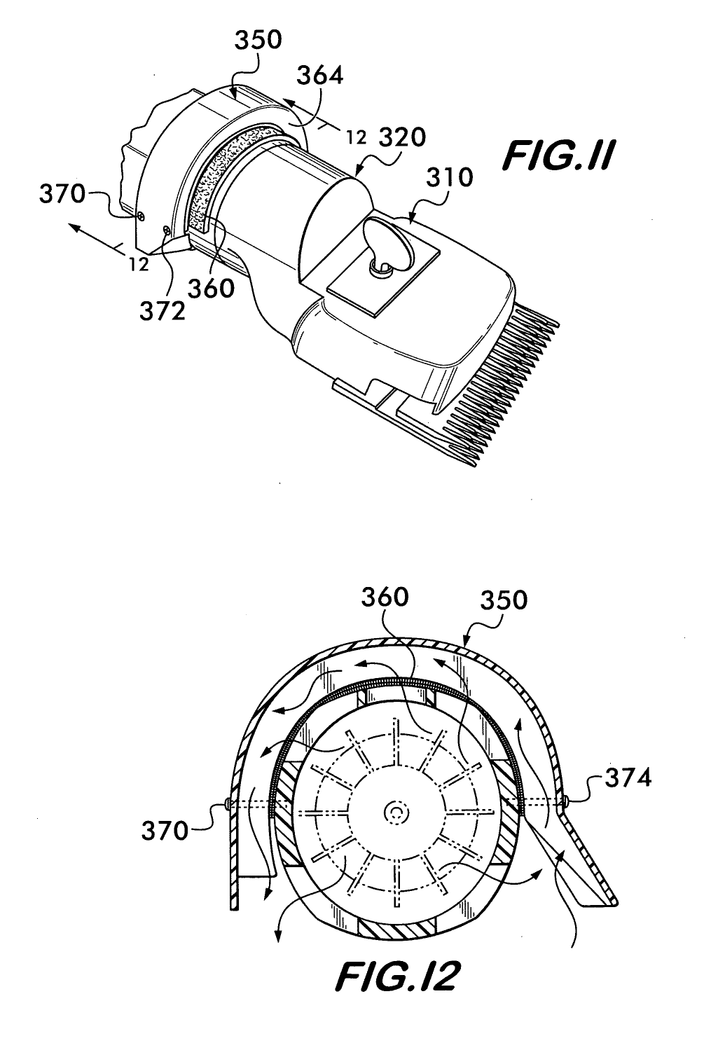

Referring now particularly to the embodiment shown in FIGS. 11 and 12, there is shown an embodiment of the present invention wherein an air and cuttings deflector attachment 350 is attached to the generally cylindrical housing 320 of a clipper 310 by mechanical means and particularly by mechanical means in the form of threaded fasteners 370, 372 and 374. The threaded fasteners may be bolts as illustrated in FIGS. 11 and 12 or any other suitable type of threaded fastener. The fasteners may be any suitable type of fasteners including non threaded fasteners such as rivets. The fasteners may be inserted into holes in housing 320 which may be drilled and threaded or they may be inserted into drilled or formed holes using self tapping threaded fasteners. The holes may be formed in the housing at the time of manufacture or they may be drilled in to the housing 320 after the time of manufacture.

The structure of deflector 350 is otherwise substantially the same as the structure described with respect to deflector 50. The lower ends of the legs of the inverted U-shaped channel of which deflector 350 is constructed may be sealed to housing 320 by means of hook and loop fasteners 260 or by other resilient means forming a tight seal between the lower ends of legs 362 and 364 and the outer surface of housing 320.

Referring now particularly to the embodiment shown in FIG. 13, there is shown an embodiment of the present invention wherein an air and cuttings deflector 450 is formed as an integral part of the generally cylindrical housing 420 of a clipper 410. Deflector 450 in this embodiment is integrally formed by molding at the time of manufacture of housing 420. Generally, the structure of deflector 450 may be substantially similar to that described with respect to deflector 50 of the embodiment described with respect to FIGS. 1 through 4 and 21 except that the structure is integrally formed as a part of housing 420. This would be formed at the time of manufacture of the clipper 410.

Referring now particularly to the embodiment shown in FIGS. 14, 15, 16, 17 and 22, there is shown an embodiment of the present invention wherein an air and cuttings deflector 550 is attached to generally cylindrical housing 520 of a clipper 510 by various means and as particularly illustrated in these figures by hook and loop fasteners 560. Any suitable means of attachment may be utilized. Clipper 510 has a generally cylindrical housing 520 with a flattened portion at 522. Clipper 510 has clipping blades 524 and outlets or outlet vents 530 for cooling motor airflow out of housing 520. Airflow is generally indicated by airflow arrows 540.

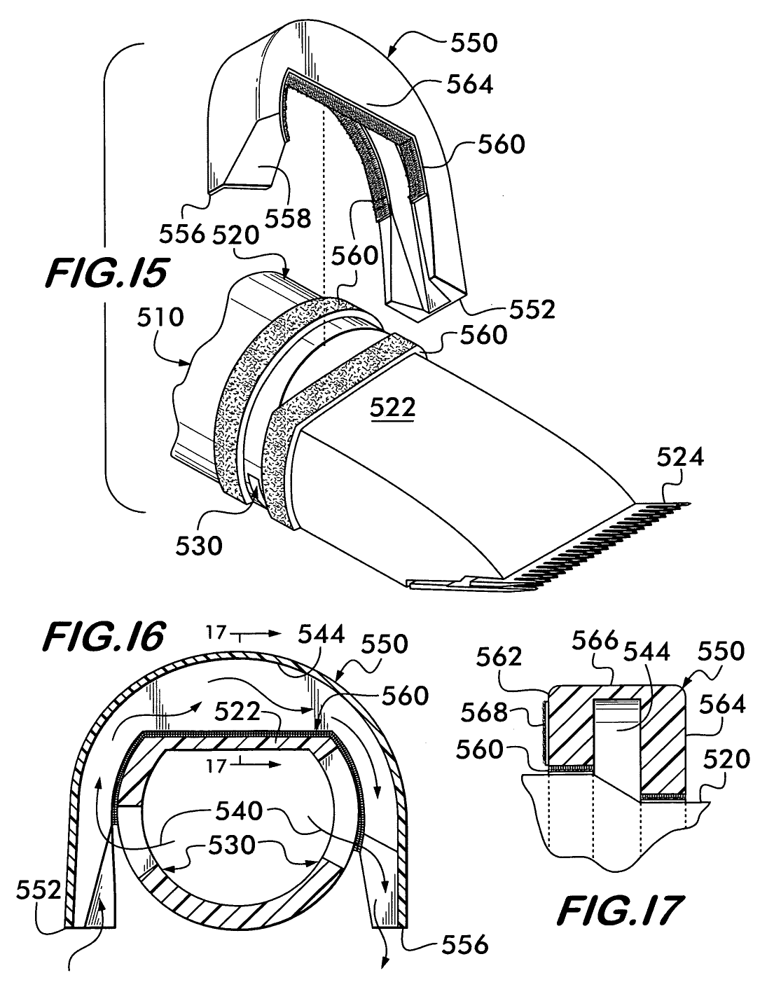

As best seen in FIGS. 15 and 16, airflow and cutting debris deflector 550 is provided with a first end 552 into which some air is drawn by the rotation of means for moving cooling air as described above and a second end 556 which is provided with a vane 558 for directing airflow backwardly along housing 520 of clipper 510. Unlike the embodiment of FIGS. 1 through 4 and 21, neither a shield nor a flared input is required on input end 552. This may be due at least in part to clipper 510 being of a smaller size than clipper 10. However, a shield and/or a flared input may optionally be provided within the scope of the present invention if desired. As with the first embodiment, vane 558 directs air and any clippings backwardly along housing 520, with backwardly being defined the same as previously and throughout. As with all of the embodiments, fan or air moving means may rotate in either direction within the scope of the present invention, and such change of rotation of direction would merely result in a reversal of the input 552 and output 556 structures.

As described with respect to the previous embodiments, the air flow deflector 550 may be a channel in the form of an inverted U-shaped having legs 562 and 564 connected at their outer end by a member 566. The lower ends of the legs 562 564 are shaped to conform to the housing 520 where the legs engage the housing of clipper 510 in the area immediately adjacent outlets or outlet vents 530. The air deflector channel or inverted U-shaped structure may be attached to or secured to the housing 520 by various suitable means such as hook and loop fasteners 560 as illustrated. The hook and loop fasteners 560 not only form a means for securing channel 544 or deflector 550 to housing 520, but also form a seal between inverted U-shaped member legs 562 and 564. As with the previous embodiments, the hook and loop fasteners may be attached to the bottom of the legs 562 and 564 and to the areas of the housing adjacent the outlets or outlet vents 530 by adhesive or other suitable means.

As discussed with respect to FIG. 4, Velcro or other cushioning material 568 may be provided on the back side of deflector 550 as best illustrated in FIG. 17 to provide a cushioning effect for the hand or fingers of an operator.

This embodiment of FIGS. 14, 15, 16, 17 and 22 specifically illustrates one generally cylindrical housing to which a deflector of the present invention may be attached wherein one of the areas adjacent the outlets or outlet vents has a flattened portion. In other clippers, both sides adjacent the outlets may have flattened portions or there may be other deviations from truly circular in cross section of the housing. It is understood that the shape of the deflector legs 562 and 564 would be adjusted to make a tight fit to the outer surface of housing 520 of clipper 510. Various other variations in the shape of the housing of the clipper may be accommodated in accordance with the present invention.

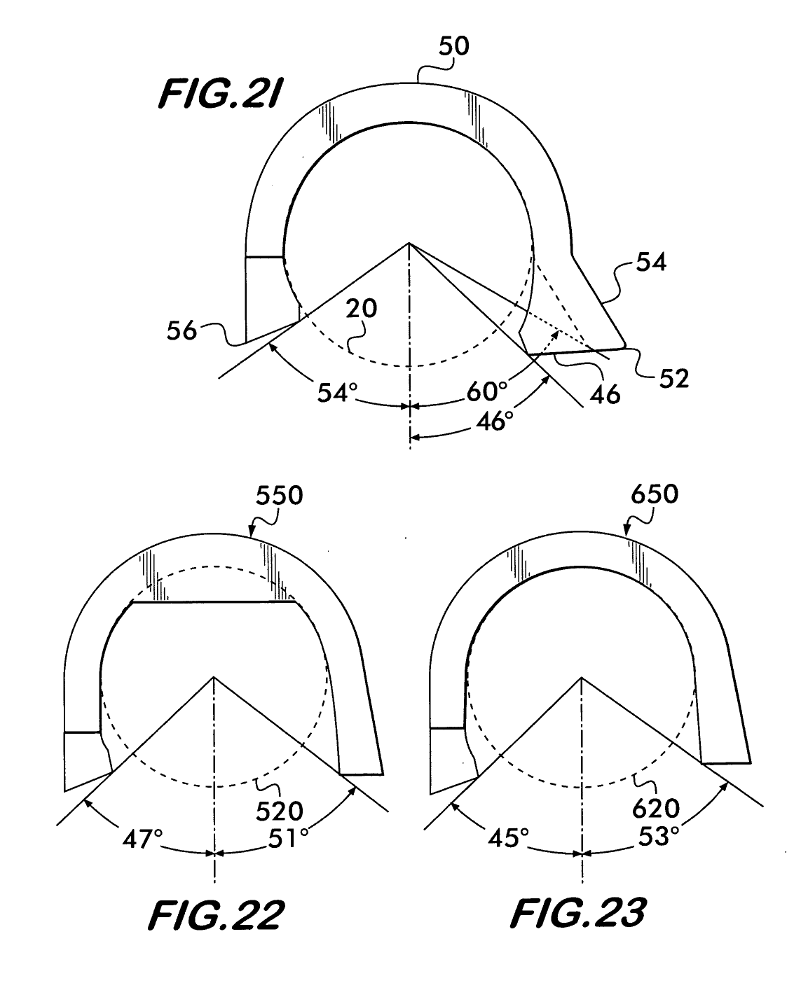

Referring to FIG. 22, there is shown a diagram of the span of deflector 550 around housing 520 of clipper 510. As illustrated therein and as indicated by the measurements on FIG. 22, the deflector may be considered to span approximately 262 degrees of the circumference of housing 520. Of course, other spans may be utilized including spans of as little of 120 degrees, but preferably more than 180 degrees. Greater or lesser degrees of span may be utilized in practicing the present invention.

The embodiment of the invention shown in FIGS. 14-17 and 22 and described herein was built and tested to successfully operate as intended deflecting air and cutting debris away from the operator.

Referring now particularly to the embodiment shown in FIGS. 18, 19, 20 and 23, there is shown an embodiment of the present invention wherein an air and cuttings deflector attachment 650 is attached to the generally cylindrical housing 620 of a clipper 610 wherein the clipper is of a smaller size than the clipper shown in FIG. 1 and is usually used for cutting human hair and other similar materials. The attachment or deflector 650 is of similar structure and construction to those described in the previous embodiments and may be attached by hook and loop fasteners 660 or other suitable attaching means. Clipper 610 is provided with clipping blade 624 and air outlets or outlet vents 630. Although this embodiment is shown with deflector 650 attached by hook and loop fasteners, such as Velcro, which not only forms a fastener, but also a seal, the deflector 650 may be attached by any suitable means including but not limited to the various mechanical means described previously. Deflector 650 is substantially similar to deflector 550 described with respect to the previous embodiment. It is provided with a first end or input end 652 and a second end or an output end 656. The output end 656 includes a backwardly deflecting vane 658. Attachment or deflector 650 operates in a manner similar to that described for the previous embodiment and particularly it deflects air and cuttings away from the operator and particularly away from the operators face.

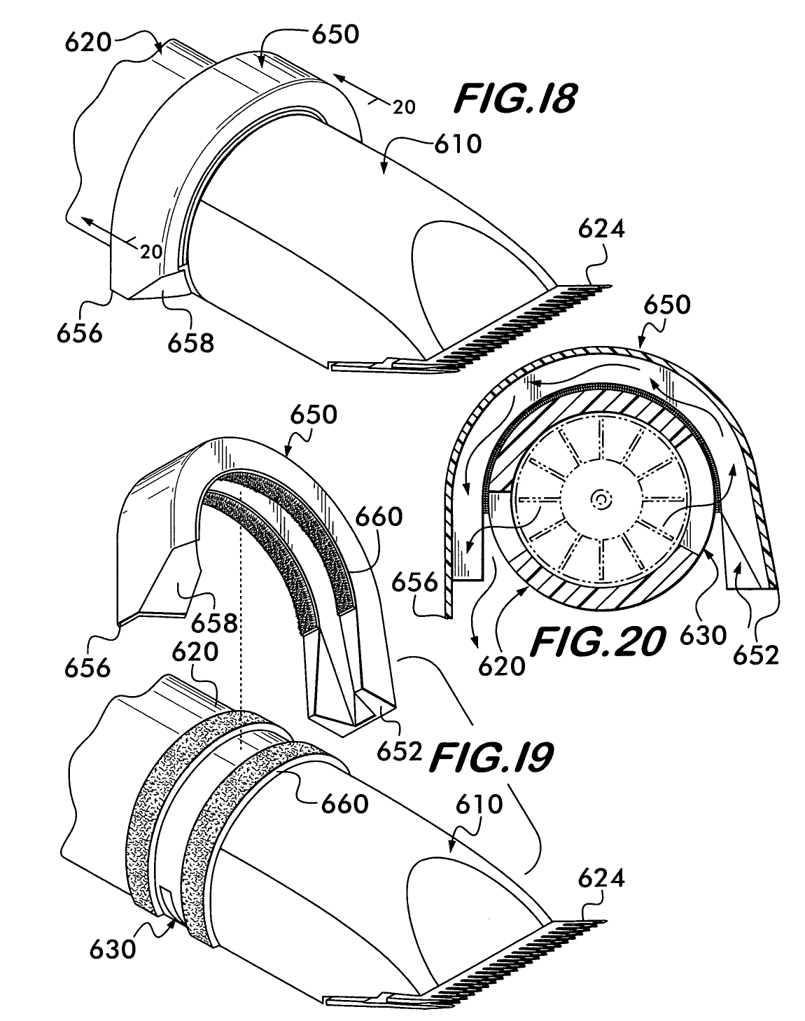

As best illustrated in FIGS. 23 and 20, deflector 650 spans a circumference of housing 620 of clipper 610 by at least 120 degrees and preferably by more than 180 degrees and most preferably by approximately 262 degrees.

The embodiment of the invention shown in FIGS. 18-20 and 23 and described herein was built and tested to successfully operate as intended deflecting air and cutting debris away from the operator.

The present invention may be embodied in other specific forms without departing from the spirit or essential attributes thereof and, accordingly, reference should be made to the appended claims, rather than to the foregoing specification as indicating the scope of the invention.

I claim:

1. Apparatus comprising:
on a clipper having an electric motor within a housing and means for forcing cooling air over said motor and through one or more outlets in said housing of said clipper, said housing comprising a generally cylindrical shape, motor cooling air flow deflector means comprising a channel over at least one of said air flow outlets;
said channel means having a first and second end and covering a span of at least 120 degrees of said housing;
said channel having said first and second ends downwardly directed, said channel being provided at said first end with a flared input and provided at said second end with a vane for directing air flow out of said channel backwardly along an outer surface of said housing.

2. An apparatus in accordance with claim 1 wherein said channel is attached to said housing.

3. Apparatus in accordance with claim 1 wherein said channel is formed unitarily as a part of said housing.

4. Apparatus in accordance with claim 2 wherein said channel is attached to said housing by a hook and loop fastener.

5. Apparatus in accordance with claim 2 wherein said channel is attached to said housing mechanically.

6. Apparatus in accordance with claim 5 wherein said mechanical attachment is comprised of a catch for engaging a side wall surface of a first outlet in said housing and a spring member for engaging a side wall of a second outlet in said housing, said channel being attachable to said housing and removable from said housing by flexing of said spring member.

7. Apparatus in accordance with claim 6 wherein a resilient seal is provided between said channel and said housing.

8. Apparatus in accordance with claim 5 wherein said mechanical means is in the form of a key hole formed in said housing and a key on said channel.

9. Apparatus in accordance with claim 1 wherein said channel is an inverted U-shaped structure which partially surrounds a portion of said housing of said clipper.

10. An apparatus in accordance with claim 1 wherein said channel is over a plurality of air flow outlets.

11. An air deflecting system for a clipper, comprising:
fan means for moving air for cooling a motor of said clipper, said fan means being within a housing of said clipper and said housing including at least one air flow outflow vent;
an attachment which deflects air from at least one outflow vent away from an operator's face; and
means for attaching said attachment to said clipper housing.

12. An air deflecting system in accordance with claim 11 wherein said attachment is C-shaped.

13. An air deflecting system as described in claim 12 wherein said attachment includes at a first and a second end inflow and outflow vents.

14. An air deflecting system as described in claim 13 wherein said attachment means comprises a hook at one end of said deflector and a spring clip at the other end.

15. An air deflecting system as described in claim 13 wherein said attachment means comprises a key hole formed in said clipper housing for receiving a key of said attachment.

16. An air deflecting system as described in claim 13 wherein said attachment means comprises hook and loop fasteners, one of said hook or loop being attached to said housing by adhesive and the other of said hook or loop being attached to said attachment by adhesive.

17. Apparatus comprising;
an air flow directing attachment adapted to be attached to an elongated housing of a clipper, said housing including therein an electric motor, and means for moving cooling air from one or more input vents in said housing to one or more output vents in said housing positioned around a periphery of said housing;
said air flow directing attachment being comprised of an inverted U-shaped structure, the opening of said inverted U-shaped structure between a first and second leg of the inverted U-shaped structure being positioned over at least one of said outlet vents, said first and second legs of said U-shaped structure being shaped to fit closely to an outer surface of said clipper housing;
said air flow directing attachment being attachable by attachment means to said outer surface of said housing; and
said air flow directing attachment having a span between a first end and a second end, said span of said air flow directing attachment being positioned on an upwardly directed surface of the periphery of said housing and preventing air flow from being directed out of an output vent in an upwardly direction and directing said air flow within the opening of said U-shaped structure in a generally downwardly direction from the periphery of said housing; and
whereby cooling motor airflow and cutting debris from the clipper is directed downwardly away from a face of an operator.

18. Apparatus in accordance with claim 17 wherein said means for moving cooling air is a rotating fan and said first end of said inverted U-shaped structure has a flared input on a side where air would be drawn into the housing by said rotating fan and a backwardly directed vane on a side where air would be directed outwardly by said rotating fan.

19. Apparatus in accordance with claim 17 wherein a sealing means is provided between the legs of said U-shaped structure and an exterior of said housing.

20. Apparatus in accordance with claim 17 wherein said air flow directing attachment is attached to said housing by attachment means in the form of hook and loop fasteners.

21. Apparatus in accordance with claim 17 wherein said air flow directing attachment is attached to said housing by attachment means in the form of a catch for engaging a sidewall of a first outlet in said housing and a spring engaging member for engaging a sidewall of a second outlet in said housing, said U shaped structure being attachable to said housing and releasable from said housing by flexing of said spring member.

22. Apparatus in accordance with claim 17 wherein said air flow directing attachment is attached to said housing by attachment means in the form of at least one key hole formed in said housing and a mating key on said U shaped structure.

23. Apparatus in accordance with claim 17 wherein said span between said first end and said second end of said U shaped structure covers at least 180 degrees of said housing.

24. Apparatus in accordance with claim 17 wherein said housing includes a flattened portion on its periphery and at least one of the legs of said inverted U-shaped structure has a mating flattened portion.
